(19) United States
(12) Patent Application Publication
(10) Pub. No.: US 2008/0235497 A1
(43) Pub. Date: Sep. 25, 2008

(54) Parallel Data Output

(76) Inventors: Jimmy J. Tomblin, Portland, OR (US); Laurence W. Grodd, Portland, OR (US); Robert A. Todd, Sherwood, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 11/945,263

(22) Filed: Nov. 26, 2007

Related U.S. Application Data
(60) Provisional application No. 60/861,159, filed on Nov. 26, 2006.

(51) Int. Cl. G06F 9/315

(52) U.S. Cl. 712/225; 712/E09.034

(57) ABSTRACT

Multiple processing threads operate in parallel to convert data, produced by one or more electronic design automation processes in an initial format, into another data format for output. A processing thread accesses a portion of the initial results data produced by one or more electronic design automation processes in an initial format and in an initial organizational arrangement. The processing thread will then store data within this portion of the initial results data belonging to a target category of the desired output organizational arrangement, such as a cell, at a memory location corresponding to that target category. It will also convert the stored data from a first data format to another data format for output. The first data format may use a relatively low amount of compression, with the second data format may use a relatively high level of compression. Each of a plurality of processing threads may operate in this manner in parallel upon portions of the initial results data, until all of the initial results data has been converted to the desired data format for output. A processing thread can then collect the converted data from the various memory locations, and provide it as output data for the electronic design automation process or processes.

### RELATED APPLICATIONS

This application claims priority under 35 U.S.C. §119 to U.S. Provisional Patent Application No. 60/861,159, filed on Nov. 26, 2006, entitled “Parallel Conversion Of Data,” and naming Laurence Grodd as inventor, which application is incorporated entirely herein by reference.

### FIELD OF THE INVENTION

The present invention is directed to the parallel creation of output data for an electronic design automation process. Various aspects of the invention may be particularly applicable to the output of data from an uncompressed or slightly compressed format, to another, more highly compressed format.

### BACKGROUND OF THE INVENTION

Many software applications can be efficiently run on a single-processor computer. Some software applications, however, have so many operations that they cannot be sequentially executed on a single-processor computer in an economical amount of time. For example, electronic design automation (EDA) software applications for creating microdevice designs may require the execution of a hundred thousand or more operations on hundreds of thousands or even millions of input data values. In order to run this type of software application more quickly, computers were developed that employed multiple processors capable of simultaneously using multiple processing threads. While these computers can execute complex software applications more quickly than single-processor computers, these multi-processor computers are very expensive to purchase and maintain. With multi-processor computers, the processors execute numerous operations simultaneously, so they must employ specialized operating systems to coordinate the concurrent execution of related operations. Further, because its multiple processors may simultaneously seek access to resources such as memory, the bus structure and physical layout of a multi-processor computer is inherently more complex than a single processor computer.

In view of the difficulties and expense involved with large multi-processor computers, networks of linked single-processor computers have become a popular alternative to using a single multi-processor computer. The cost of conventional single-processor computers, such as personal computers, has dropped significantly in the last few years. Moreover, techniques for linking the operation of multiple single-processor computers into a network have become more sophisticated and reliable. Accordingly, multi-million dollar, multi-processor computers are now typically being replaced with networks or “farms” of relatively simple and low-cost single processor computers.

Shifting from single multi-processor computers to multiple networked single-processor computers has been particularly useful where the data being processed has parallelism. With this type of data, one portion of the data is independent of another portion of the data. That is, manipulation of a first portion of the data does not require knowledge of or access to a second portion of the data. Thus, one single-processor computer can execute an operation on the first portion of the data while another single-processor computer can simultaneously execute the same operation on the second portion of the data. By using multiple computers to execute the same operation on different groups of data at the same time, i.e., in “parallel,” large amounts of data can be processed quickly. This use of multiple single-processor computers has been particularly beneficial for analyzing circuit design data using electronic design automation (EDA) tools. With this type of data, one portion of the design, such as a semiconductor gate in a first area of a microcircuit, may be completely independent from another portion of the design, such as a wiring line in a second area of the microcircuit. Some electronic design automation operations, such as operations defining a minimum width check of a structure, can thus be executed by one computer for the gate while another computer executes the same operations for the wiring line.

While parallel processing has substantially decreased the time required to execute electronic design automation software tools, many of these tools still require a large amount of time to actually output their results. Frequently, an initial circuit design will be analyzed using a relatively uncompressed data format. The output provided by a microdevice analysis tool, however, may contain significantly more information than the initial circuit design. For example, a polygon in an initial circuit design may have only four vertices. If the design is revised during an optical proximity correction (OPC) process, however, then the results output by the process may describe a shape corresponding to that polygon using several thousand vertices. Accordingly, the results output by an electronic design automation process may need to be in a significantly more compressed data format for use by another electronic design automation process or review by a designer. While an electronic design automation tool may execute a design analysis process in parallel using multiple processing threads, these tools conventionally output the analysis results into a desired data format using only a single processing thread. Thus, depending upon the size and complexity of the initial circuit design, converting the results of an electronic design automation process into the desired data format for output can require a substantial amount of time.

### SUMMARY OF THE INVENTION

Advantageously, various aspects of the invention provide techniques to more efficiently output the results produced by one or more electronic design automation processes into a desired data format. As will be discussed in detail below, embodiments of both tools and methods implementing these techniques have particular application for outputting design data produced by an electronic design automation process into a compressed data format.

According to various embodiments of the invention, multiple processing threads operate in parallel to convert data, produced by one or more electronic design automation processes in an initial format, into another data format for output. For example, some electronic design automation processes may operate on layout design data in a relatively uncompressed data format. It may be desirable, however, to output the data for subsequent use by a designer or another electronic design automation process in a second, more compressed, data format. With various implementations of the invention, a first thread may access a portion of the initial results data in an initial organizational arrangement, and store data within this portion belonging to a target category of the desired output organizational arrangement, such as a cell, at a memory location corresponding to that target category. It may also convert the stored data from a first data format to another data format for output. The first data format may use a relatively low amount of compression, with the second data format may use a relatively high level of compression.

With various examples of the invention, each of a plurality of threads may concurrently operate in this manner upon different portions of the initial results data. With these embodiments of the invention, one or more threads may identify data belonging to the same target category of the desired output organizational arrangement. With still other embodiments of the invention, each of a plurality of threads may concurrently operate in this manner on the same portion of the initial data. With these embodiments of the invention, each thread may identify data belonging to a different target category of the desired output organizational arrangement.

These and other features and aspects of the invention will be apparent upon consideration of the following detailed description.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 schematically illustrates an example of a family of software tools for automatic design automation that may be employed with various embodiments of the invention.

FIG. 4 illustrates an example of such a circuit design that may be operated upon by an electronic design automation process used in conjunction with various embodiments of the invention.

FIGS. 5A and 5B illustrate a flowchart showing the operation of processing threads according to various embodiments of the invention.

FIG. 6 illustrates a stack configuration that may be employed according to various embodiments of the invention.

### DETAILED DESCRIPTION OF PREFERRED EMBODIMENTS

### Operating Environment

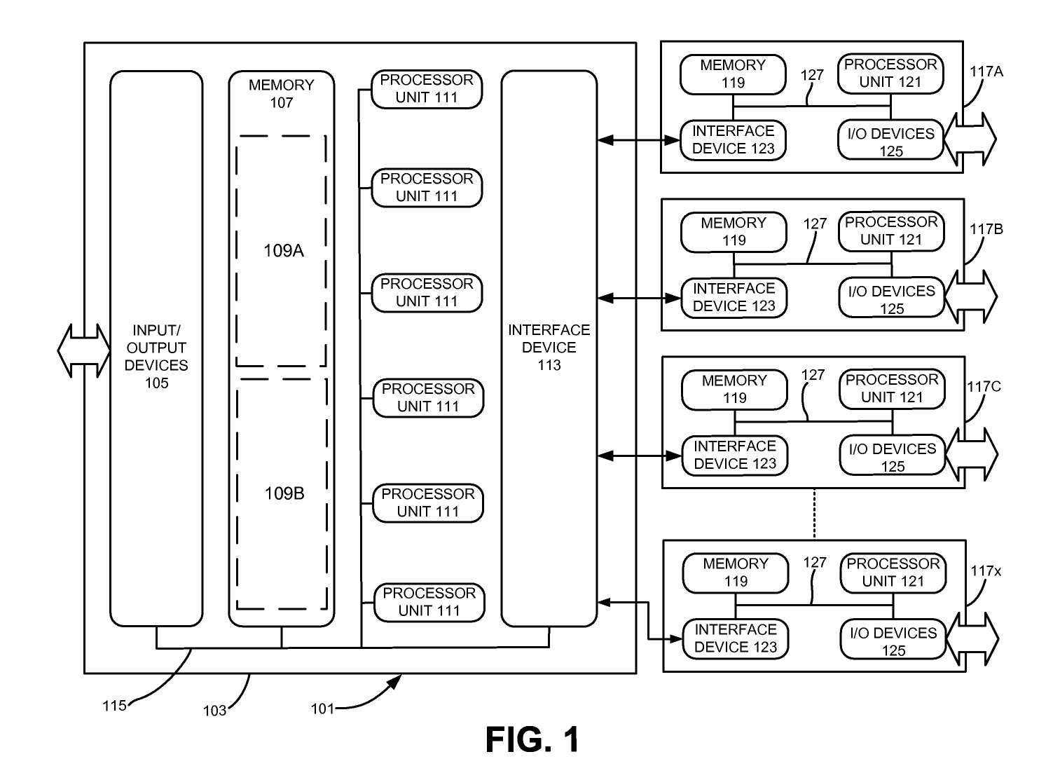

As will be discussed in more detail below, various embodiments of the invention relate to outputting data from one or more electronic design automation processes. As will be appreciated from the following description, various examples of the invention may be embodied by one or more programmable computers executing software instructions, or by a computer-readable storage medium having software instructions stored thereon for execution by one or more programmable computers. Accordingly, the components and operation of a generic programmable computer system with which various embodiments of the invention may be implemented will first be described. Due to the complexity of some electronic design automation processes and the large size of many circuit designs, various electronic design automation are configured to operate on a computing system capable of simultaneously running multiple processing threads. Accordingly, the components and operation of a computer network having a host or master computer and one or more remote or servant computers therefore will be described in particular with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

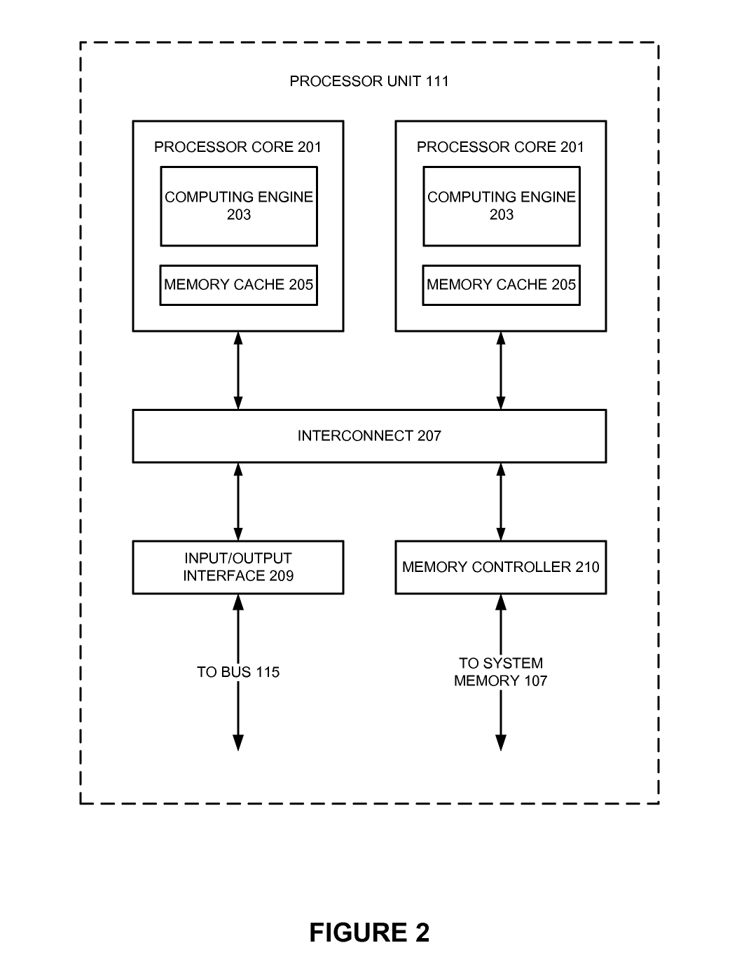

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls thru tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer system illustrated in FIG. 1 and FIG. 2 is provided as an example only, and it not intended to suggest any limitation as to the scope of use or functionality of alternate embodiments of the invention.

### Electronic Design Automation

As previously noted, various embodiments of the invention are related to electronic design automation, in particular, various implementations of the invention may be used to output the results produced by the operation of electronic design automation software tools that identify, verify and/or modify design data for manufacturing a microdevice, such as a microcircuit. As used herein, the terms “design” and “design data” are intended to encompass data describing an entire microdevice, such as an integrated circuit device or micro-electromechanical system (MEMS) device. These terms also are intended to encompass a smaller set of data describing one or more components of an entire microdevice, however, such as a layer of an integrated circuit device, or even a portion of a layer of an integrated circuit device. Still further, the terms “design” and “design data” are intended to encompass data describing more than one microdevice as well, such as data to be used to create a mask or reticle for simultaneously forming multiple microdevices on a single wafer.

As previously noted, various examples of the invention may be particularly applicable for outputting data produced by one or more electronic design automation processes, such as electronic design automation processes that verify a circuit design complies with specified requirements, identifying problems in the design, modifying the circuit design to improve its manufacturability, or some combination thereof. Accordingly, to facilitate an understanding of various embodiments of the invention, one family of tools for automatic design automation, directed to the analysis and modification of a design for an integrated circuit, will now be generally described.

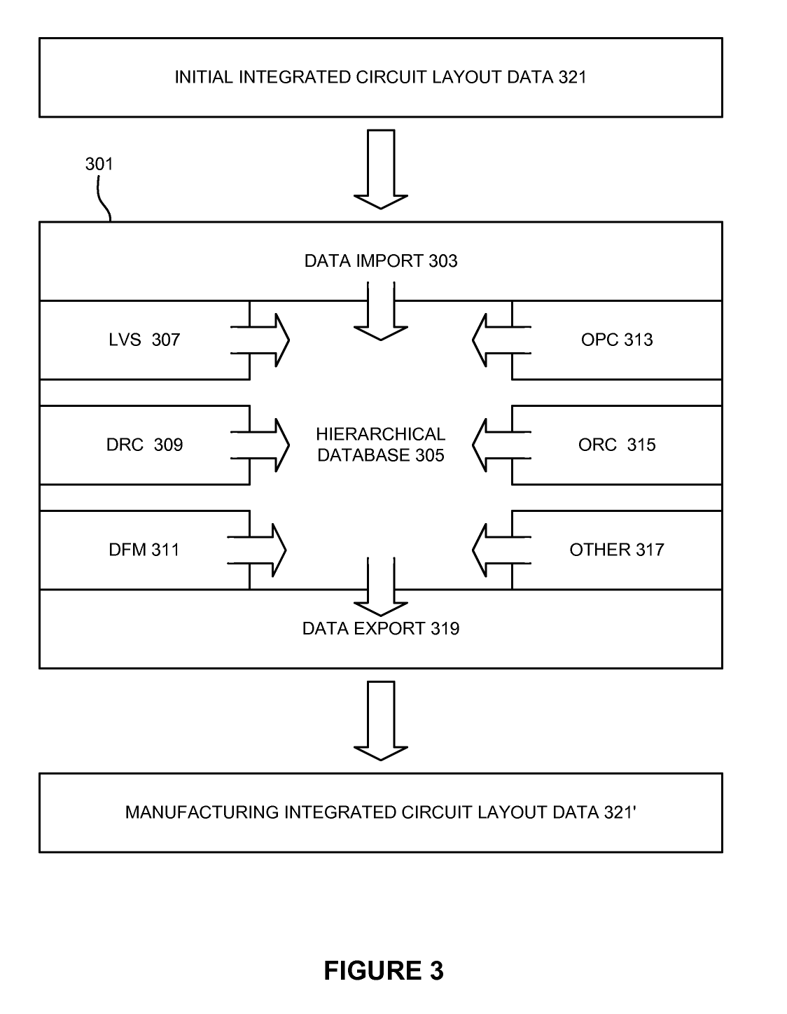

Turning now to FIG. 3, an analysis system 301, which may be implemented by a variety of different software application tools, includes a data import module 303 and a hierarchical database 305. The analysis system 301 also includes a layout-versus-schematic (LVS) verification module 307, a design rule check (DRC) module 309, a design-for-manufacturing (DFM) module 311, an optical proximity correction (OPC) module 313, and an optical proximity rule check (ORC) module 315. The analysis system 301 may further include other modules 317 for performing additional functions as desired, such as a phase shift mask (PSM) module (not shown), an etch simulation analysis module (not shown) and/or a planarization simulation analysis module (not shown). The system 301 also has a data output module 319. One example of tools that may be employed for such an analysis system is the Calibre family of software tools available from Mentor Graphics Corporation of Wilsonville, Oreg.

Initially, the system 301 receives data 321 describing a physical layout design for an integrated circuit. The layout design data 321 may be in any desired format, such as, for example, the Graphic Data System II (GDSII) data format or the Open Artwork System Interchange Standard (OASIS) data format proposed by Semiconductor Equipment and Materials International (SEMI). Other formats for the data 321 may include an open source format named Open Access, Milkyway by Synopsys, Inc., and EDDM by Mentor Graphics, Inc. The layout data 321 includes geometric elements for manufacturing one or more portions of an integrated circuit device. For example, the initial integrated circuit layout data 321 may include a first set of polygons for creating a photolithographic mask that in turn will be used to form an isolation region of a transistor, a second set of polygons for creating a photolithographic mask that in turn will be used to form a contact electrode for the transistor, and a third set of polygons for creating a photolithographic mask that in turn will be used to form an interconnection line to the contact electrode. The initial integrated circuit layout data 321 may be converted by the data import module 303 into a format that can be more efficiently processed by the remaining components of the system 301.

Once the data import module 303 has converted the original integrated circuit layout data 321 to the appropriate format, the layout data 321 is stored in the hierarchical database 305 for use by the various operations executed by the modules 305-317. Next, the layout-versus-schematic module 307 checks the layout design data 321 in a layout-versus-schematic process, to verify that it matches the original design specifications for the desired integrated circuit. If discrepancies between the layout design data 321 and the logical design for the integrated circuit are identified, then the layout design data 321 may be revised to address one or more of these discrepancies. Thus, the layout-versus-schematic process performed by the layout-versus-schematic module 307 may lead to a new version of the layout design data with revisions. The layout data 321 may be manually revised by a user, automatically revised by the layout-versus-schematic module 307, or some combination thereof.

Next, the design rule check module 309 confirms that the verified layout data 321 complies with defined geometric design rules. If portions of the layout data 321 do not adhere to or otherwise violate the design rules, then the layout data 321 may be modified to ensure that one or more of these portions complies with the design rules. The design rule check process performed by the design rule check module 309 thus also may lead to a new version of the layout design data with various revisions. Again, the layout data 321 may be manually modified by a user, automatically modified by the design rule check module 309, or some combination thereof.

The modified layout data 321 is then processed by the design for manufacturing module 311. As previously noted, a “design-for-manufacture” process attempts to identify elements in a design representing structures with a significant likelihood of being improperly formed during the manufacturing process. A “design-for-manufacture” process may additionally determine what impact that likelihood of the improper formation of the identified structures will have on the yield of devices manufactured from the circuit design, and/or modifications that will reduce the likelihood that the identified structures will be improperly formed during the manufacturing process. For example, a “design-for-manufacture” (DFM) software tool may identify wires that are connected by single vias, determine the yield impact based upon the probability that each individual single via will be improperly formed during the manufacturing process, and then identify areas where redundant visa can be formed to supplement the single vias.

It should be noted that, in addition to the term “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

The processed layout data 321 is then passed to the optical proximity correction module 313, which corrects the layout data 321 for manufacturing distortions that would otherwise occur during the lithographic patterning. For example, the optical proximity correction module 313 may correct for image distortions, optical proximity effects, photoresist kinetic effects, and etch loading distortions. The layout data 321 modified by the optical proximity correction module 313 then is provided to the optical process rule check module 315

The optical process rule check module 315 (more commonly called the optical rules check module or ORC module) ensures that the changes made by the optical proximity correction module 313 are actually manufacturable, a “downstream-looking” step for layout verification. This compliments the “upstream-looking” step of the LVS performed by the LVS module 307 and the self-consistency check of the DRC process performed by the DRC module 309, adding symmetry to the verification step. Thus, each of the processes performed by the design for manufacturing process 311, the optical proximity correction module 313, and the optical process rule check module 315 may lead to a new version of the layout design data with various revisions.

As previously noted, other modules 317 may be employed to perform alternate or additional manipulations of the layout data 321, as desired. For example, some implementations of the tool 301 may employ, for example, a phase shift mask module. As previously discussed, with a phase-shift mask (PSM) analysis (another approach to resolution enhancement technology (RET)), the geometric elements in a layout design are modified so that the pattern they create on the reticle will introduce contrast-enhancing interference fringes in the image. The system 301 also may alternately or additionally employ, for example, an etch simulation analysis processes or a planarization simulation analysis processes. The process or processes performed by each of these additional modules 317 may also lead to the creation of a new version of the layout data 321 that includes revisions.

After all of the desired operations have been performed on the initial layout data 321, the data output module 319 converts the processed layout data 321 from the format employed by the modules 305-317 into the desired output format. For example, if one or more of the modules 305-317 operates on data in a proprietary data format, the data output module 319 may output the process results in the OASIS data format. As will be discussed in more detail below, the data output module 319 may be implemented employing a parallel data output technique according to various embodiments of the invention.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout. Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

### Microdevice Design Data Organization

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with specified design rules. With the above example, instead of having to analyze each feature in the entire 128 kB memory array, a design rule check process can analyze the features in a single bit cell. If the cells are identical, then the results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

In addition to employing hierarchy, design data may alternately or additionally be organized into layers of data. For example, with various embodiments of the invention, layout design data may include two different types of data: “drawn layer” design data and “derived layer” design data. As previously noted, physical design data or “layout” design data will represent the geometric elements that will be written onto a mask used to fabricate the desired microcircuit device in a photolithographic process at a foundry. The drawn layer data therefore will describe geometric elements that will be used to form structures in layers of material to produce the integrated circuit. The drawn layer data will usually include polygons that will be used to form structures in metal layers, diffusion layers, and polysilicon layers. The derived layers will then include geometric elements made up of combinations of drawn layer data and other derived layer data. Thus, with a transistor gate, derived layer design data describing the gate may be derived from the intersection of a polygon in the polysilicon material layer and a polygon in the diffusion material layer.

For example, a design rule check process performed by the design rule check module 309 typically will perform two types of operations: “check” operations that confirm whether design data values comply with specified parameters, and “derivation” operations that create derived layer data. A transistor gate design data thus may be created by the following derivation operation:

gate=diff AND poly

The results of this operation will be a “layer” of data identifying all intersections of diffusion layer polygons with polysilicon layer polygons. Likewise, a p-type transistor gate, formed by doping the diffusion layer with n-type material, is identified by the following derivation operation:

pgate=nwell AND gate

The results of this operation then will be another “layer” of data identifying all transistor gates (i.e., intersections of diffusion layer polygons with polysilicon layer polygons) where the polygons in the diffusion layer have been doped with n-type material.

A check operation performed by the design rule check module 309 will then define a parameter or a parameter range for a data design value. For example, a user may want to ensure that no metal wiring line is within a micron of another wiring line. This type of analysis may be performed by the following check operation:

external metal<1

The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

### Microdevice Design Data Formats

Microdevice design data can be configured in a number of different data formats. In addition to different proprietary data formats used by various electronic design automation tools, there are a number of standardized data formats well known to those of ordinary skill in the art, such as Graphic Data System II (GDSII), Open Artwork System Interchange Standard (OASIS), Open Access, Milkyway, and EDDM. These data formats may provide for different amounts of compression. For example, the GDSII data format provides for a relatively small amount of compression, while the OASIS data format allows a relatively large amount of compression.

The differences between the OASIS data format and the GDSII data format illustrate the impact of compression on data output from an electronic design automation process. For example a circuit design written in the OASIS data format may be approximately one tenth the size of a corresponding circuit design written in the GDSII data format. One compression feature provided by the OASIS data format is the use of compact coordinate data with variable length numbers. Using this feature, for example, a “0” value in the data does not require 8 bytes. Another compression feature provided by the OASIS format is the ability to embed compressed blocks of data into a file. For example, a user can employ the well known “GZip”-type compression algorithm to all of the data in a cell, which reduces the size of the cell, and then embed this compressed file within the data file. Yet another compression feature provided by the OASIS data format is modality. With this feature, if a particular geometric feature or placement is similar to another feature or placement, then that similar geometric feature or placement can be concisely described by primarily referencing the differences between the original geometric feature or placement and the similar geometric feature or placement. For example, a similar geometric feature or placement can be described by difference data such as a starting x-y coordinate, layer, data type, width and height of a rectangle, etc.

Still further, if a set of geometric features is repeated within a cell, then these repetitions of the initial set of geometric features can be more concisely described by referring to the initial set of geometric features. More particularly, the OASIS data format may support four different types of repetition modalities. With a Type I repetition, for example, an array of geometric features is repeated in both an x-direction and a y-direction. Accordingly, this type of repetition of a set of geometric features can be described by a starting coordinate, an offset in the x-dimension, an offset in the y-dimension, an x-spacing between the geometric features in the array, and a y-spacing between the geometric features in the array.

Similarly, with a Type II repetition, a column of geometric features is repeated in only an x-direction. Accordingly, this type of repetition of a set of geometric features can be described by a starting coordinate, an offset in the x-dimension, and an x-spacing between the geometric features in the array. Similarly, with a Type III repetition, a row of geometric features is repeated in only a y-direction. This type of repetition thus can be described by a starting coordinate, an offset in the y-dimension, and a y-spacing between the geometric features in the array. With Type X and Type XI repetitions, the set of geometric features may be sparse, with no regular spacing between the geometric features in the set. These types of repetitions can still be compactly described, however, with a starting point, a dimension (i.e., the number of elements in the repetition), and a series of Δx and Δy offsets between the geometric features in the array. In addition to geometric features, the OASIS data format also allows modality to be used to define placements.

As previously noted, the GDSII data format is a relatively non-compact data format as compared to the OASIS data format. With the GDSII data format, geometric features consist of 8-byte vertices in integral numbers, so there are no variable length numbers as allowed by the OASIS data format. Further, each the GDSII format does not provide any type of modality, so each geometric feature description must include both its layer and data type. Still further, while GDSII allows the use of repetitions to describe regular arrays of placements, it does not allow repetitions to be employed to describe geometric features. The differences between the OASIS data format and the GDSII data format are described in more detail in the article “Using OASIS To Contain The Size Of Data Files In The Manufacture Of Photomasks” by Steffen Schulze, PhD, published by Micromagazine.com, which article is incorporated herein by reference.

Accordingly, there may be a great deal of processing overhead required to convert data generated by an electronic design automation process in an initial, relatively uncompressed data format into an output data format providing for a relatively large amount of data compression, such as the OASIS data format. For example, a processing thread performing the conversion process may need to examine geometric features in the initial data Format to identify repeating sets that can be described with repetitions in the OASIS format. This process is strongly time dependent. If the processing thread compares a 4×4 array of geometric features with a 16×16 array of adjacent geometric features, for example, it may not identify any repeat of the 4×4 array. If, however, the processing thread continues the analysis to compare a 16×16 array of geometric features (that includes the initial 4×4 array) with a 64×64 array of adjacent geometric features, then the thread may identify a repeat of the 16×16 array. Alternately, it may perform this analysis (expending the associated processing overhead), but still not identify a repeat of the 16×16 array.

### Creation Of Results Data

Table 1 describes an example of a microdevice design analysis process in psuedocode. In particular, Table 1 lists the flow of an algorithm for inserting “dummy” geometric elements (typically rectangles) to a layer of data in the design in order to achieve a desired amount of structure density per unit area. An example of this design flow might be implemented using, e.g., the Calibre family of electronic design tools available from Mentor Graphics Corporation of Wilsonville, Oreg.

TABLE 1
LAYOUT PATH in.gds

| | |
|---|---|
| LAYOUT SYSTEM | GDSII |
| LAYOUT PRIMARY | “TOPCELL” |

DRC RESULTS DATABASE out.oas OASIS
.
.
.
LAYTER M2 2
.
.
.
MS_DENS = DENSITY M2 <= 0.25 WINDOW 5.0 STEP 1.0
M2_FILL_AREA = M2_DENS NOT M2
DM2 = RECTANGLES .1.1.1 INSIDE OF LAYER M2_FILL_AREA
.
.
.
M2 { COPY M2 } DRC CHECK MAP M2 OASIS 2 0
DM2 { COPY M2 } DRC CHECK MAP DM2 OASIS 2 1

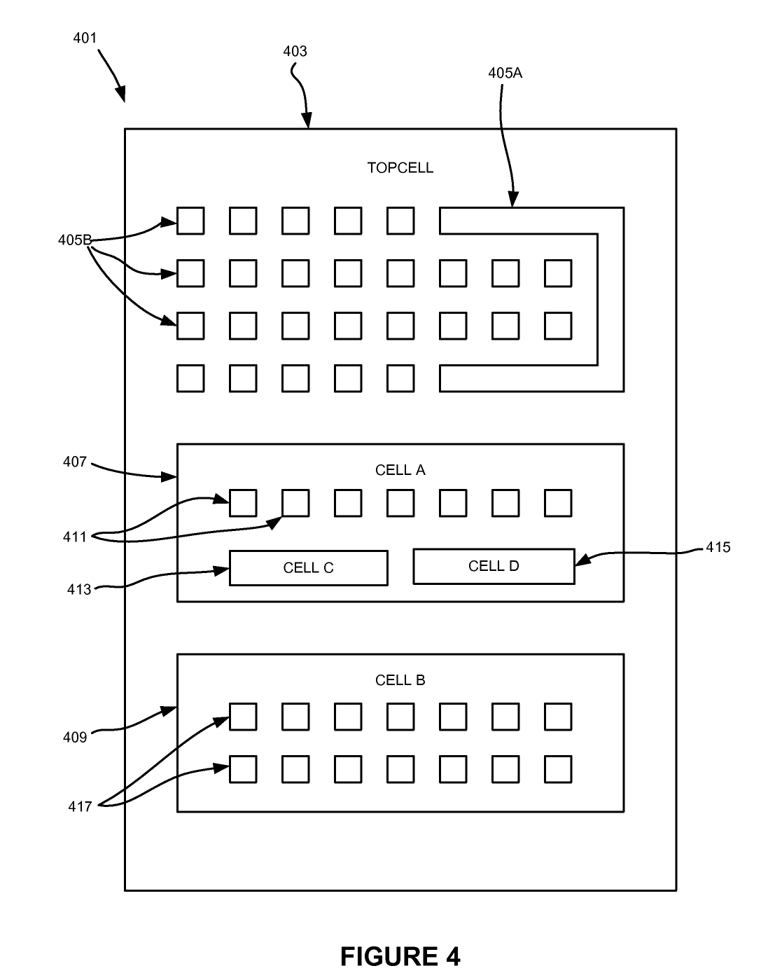

Thus, this flow specifies the series of inputs that will be employed by the electronic design automation process to operate on a hierarchical microdevice design. In particular, it identifies for the electronic design automation process both the database from which the input data is being retrieved (i.e., in.gds), a particular physical layout design that will be read into the electronic design automation tool (i.e., the circuit design entitled “GDSII”) in the GDSII data format, and the primary cell in the design (i.e., the cell entitled “Topcell”). FIG. 4 illustrates an example of such a circuit design. As seen in this figure, the design 401 has a high level cell 403 named “Topcell.” This high level cell 403 includes a plurality of geometric elements 405. It also includes two lower level cells 407 and 409, entitled cell A and cell B, respectively. The cell 407 (i.e., cell A) itself includes a plurality of geometric elements 411. It also has two lower level cells 413 and 415, entitled cell C and cell D, respectively. As will be appreciated by those of ordinary skill in the art, each of these two lower level cells 413 and 415 may each contain one or more geometric elements (not shown), one or more still lower level cells (not shown), or some combination thereof. The cell 409 (i.e., cell B) includes a plurality of geometric elements 417.

The flow listed in Table 1 also specifies the outputs of the electronic design automation process. In particular, this flow specifies that the results will be provided to a design rule check database in the OASIS data format. The outputs are provided to the design rule check database in response to the execution of the “CHECK MAP” command listed in the flow. Of course, the flow also defines the operation (or operations) that will be performed using the specified input data. With the example shown in Table 1, areas in the design with a geometric element density below a threshold value are identified, and “dummy” geometric elements are added to those identified areas.

As previously noted, a hierarchical microdevice design like the design illustrated in FIG. 4 may contain a series of cell definitions. A cell definition may contain a description of one or more geometric elements. A geometric element typically will be a polygon, such as a rectangle, an edge, or a combination of edges, and each geometric element typically will have a layer and data type associated with it. A cell definition also may include a placement, which describes the placement of a lower level cell within the cell. Thus, the cell definition of the cell 403 (i.e., the cell entitled “Topcell”) will include a description of the geometric elements 405. The cell definition of the cell 403 also will include placements for the lower level cells 407 (i.e., Cell A) and 409 (i.e., Cell B). A cell placement will typically include a reference to the cell, a base coordinate where the lower level cell is located within the higher level cell, and a transform describing the orientation of the lower level cell.

With the flow described in Table 1, circuit design data is input into the electronic design automation tool in the Graphic Design System II (GDSII) format. The electronic design automation tool, operates on the design using its own data format, and initially provides the results of the process in its own data format. As indicated in the design flow shown in Table 1, however, the results of the process flow must be output in the Open Artwork System Interchange Standard (OASIS) format before being provided to the design rule check database.

### Parallel Output Of Data

As previously noted, various implementations of the invention may be employed to convert the results of one or more electronic design automation processes, such as the process referred to in the design flow of Table 1, into a desired output data format, such as the OASIS data format. With various examples of the invention, the output process will be performed for the results produced by one or more electronic design automation tools, such as the Calibre family of software tools available from Mentor Graphics Corporation of Wilsonville, Oreg. With these tools, the results data may be provided in a proprietary data format having a relatively small amount of compression. Further, the result data may be organized according to layers, as discussed in detail above. As also previously noted, a designer may wish for the results data to be output in a standard data format, such as the OASIS data format. Further, a designer may wish for the output data to be organized according to a hierarchical arrangement.

As will be discussed in more detail below, various implementations of the invention may output the results data in two phases. In the first phase, referred to as the “addition” phase, a processing thread accesses a set of the results data in its initial data format and organizational arrangement. The processing thread will then analyze this set of data for data that belongs to a target category of the organizational arrangement desired for the output. For example, if the output data is to be organized according a hierarchical arrangement, then the thread may analyze the data set to identify a datum or data belonging to a particular cell. After the processing thread identifies datum or data in the data set that belongs to the target category, it saves that datum or data to a memory location corresponding to that target category. Moreover, the processing thread will convert the identified data from the initial data format employed by the electronic design automation process to the desired output data format.

With various examples of the invention, each of a plurality of threads may concurrently operate in this manner upon different sets of results data provided by the electronic design automation process or processes. With these implementations of invention, each thread will identify data belonging to the same target category of the desired output organizational arrangement. With still other embodiments of the invention, however, each of a plurality of threads may alternately or additionally concurrently operate in this manner on the same set of data results data in the initial data format. With these embodiments of the invention, each separate thread analyzing the same initial data set will identify data belonging to a different target category of the desired output organizational arrangement.

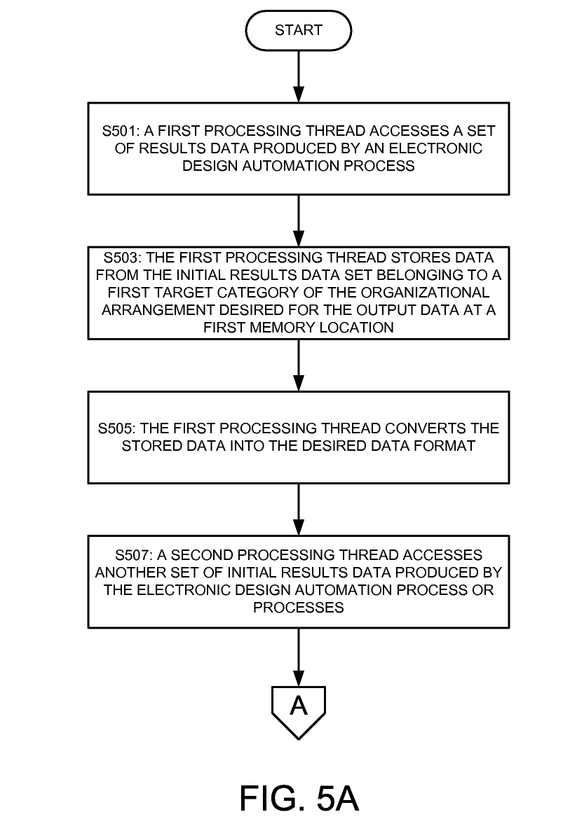

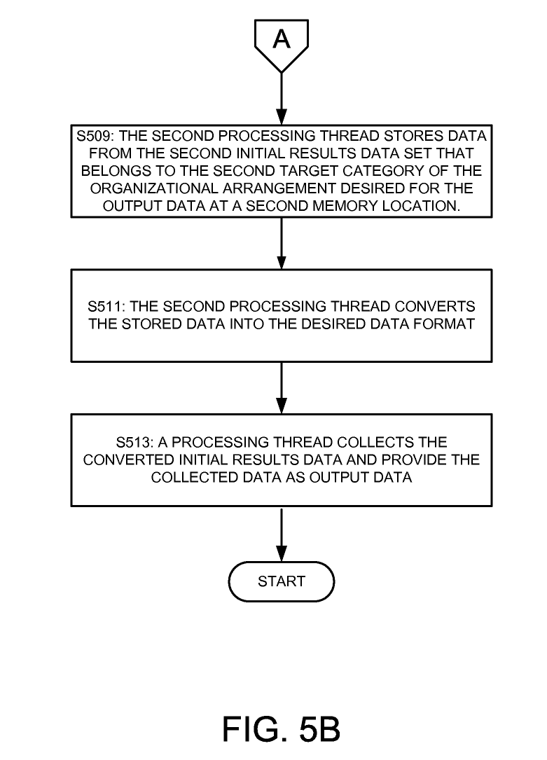

Once the initial results data provided by the electronic design automation process or processes have been analyzed, then the second “conclusion” phase collects the data to generate the desired output. For example, a processing thread may collect the converted data from each of the memory locations, and combine the collected data into a new microdevice design according to the desired organizational arrangement. The addition and collection phases of various implementations of the invention will be discussed in more detail with regard to the flowchart illustrated in FIGS. 5A and 5B.

Initially, in step S501, a first processing thread accesses a set of initial results data produced by an electronic design automation process or processes. With various examples of the invention, the first processing thread may access the set of initial results data by analyzing the data from its original memory location. Still other implementations of the invention, however, may access the set of initial results data by making a copy of the data from its original memory location, and saving the copied set of data at a temporary memory location for subsequent operations.

As previously noted, the initial results data produced by an electronic design automation process will typically be in a proprietary format. Thus, the initial results data may be in a data format having a level of compression similar to, e.g., GDSII. Further, the initial results data will be organized according to an organizational arrangement employed by the electronic design automation process. For example, electronic design automation tools from the Calibre family of the electronic design automation tools may store the initial results data in a hierarchical database. With this type of hierarchical database, the geometrical elements in a physical layout design will be organized hierarchically. In addition, the hierarchical data may be further organized based upon an arrangement of layers, as described above. Thus, the geometrical elements occurring both in a particular layer and in a particular hierarchical cell may share a unique cell/layer coordinate value.

Next, in step S503, the first processing thread stores data from the initial results data set belonging to a first target category of the organizational arrangement desired for the output data at a first memory location. For example, referring back to FIG. 4, the cell 403 may include both a geometric element 405A that represents a metal wiring line and multiple geometric elements 405B that represent metal fill structures to establish a desired structure density. Accordingly, in the initial results data, the data describing the geometric element 405A will be included in a first design layer, such as a layer entitled METAL1. The data describing the geometric elements 405B, however, will be in another design layer, such as a design layer entitled METAL_FILL. Accordingly, if the initial results data set accessed by the first processing thread is data for the cell 403 falling within the design layer entitled METAL_FILL, that data set may include the data describing the geometric elements 405B (i.e., the fill structures), but not the data describing the geometric element 405A (i.e., the wiring line). If the output data is to be arranged in a hierarchical organizational arrangement (like that illustrated in FIG. 4), then the first processing thread will store the data describing the geometric elements 405B at a memory location corresponding to the hierarchical cell 403 (i.e., “Topcell”). For example, the first processing thread data may store the initial results data describing the geometric elements 405B in a temporary database from memory address 0 to memory address x.

With some implementations of the invention, the first processing thread may employ an offset map to record the memory location at which the initial results data set belonging to a first target category of the organizational arrangement is stored. For example, the first processing thread may employ an offset map associated with the hierarchical cell 403. When the first processing thread stored the initial results data describing the geometric elements 405B, it would lock both the offset map and the temporary database. After storing the initial results data describing the geometric elements 405B at the memory location ranging from memory address 0 to memory address x, it would update the offset map for the cell 403 to include a reference to this memory location. It would then release both the offset map and the temporary database.

It should be noted that, with various embodiments of the invention, all of the data in a set of initial results data accessed by the first processing thread will belong to a single target category of the organizational arrangement desired for the output data. For example, as previously noted, electronic design automation tools in the Calibre family of software tools may organize initial results data according to both layers and a hierarchical arrangement. Thus, all of the data in set of initial results data sharing a single cell/layer coordinate value will typically belong to the same target category. With still other embodiments of the invention, however, a set of initial results data may include data belonging to different target categories of the organizational arrangement desired for the output data. With these implementations of the invention, the first processing thread may perform an additional analysis to separate data in the initial results data set belonging to the first target category from data belonging to other target categories. For example, each geometric element in the initial results data set may include category information indicating to which target category it belongs. The first processing thread can then use this category information to identify the data in the set of initial results data belonging to the first target category.

Next, in step S505, the first processing thread converts the stored data into the desired data format. For example, the first processing thread may convert the stored data from, e.g., a proprietary data format used by the electronic design automation process, into a standard data format, such as the OASIS data format. With various implementations of the invention, the first processing thread may use any conventional technique or combination of techniques to convert the stored data into the desired data format. It should be noted that, with alternate examples of the invention, the first processing thread may convert the data before storing it at the memory location corresponding to the first target category.

In step S507, a second processing thread accesses another set of initial results data produced by the electronic design automation process or processes. Like the first processing thread, the second processing thread may access the set of initial results data by analyzing the data directly from its original memory location, or by making a copy of the data from its original memory location, and saving the copied set of data at a temporary memory location for subsequent operations.

With various examples of the invention, the second processing thread will access a different set of initial results data than the set accessed by the first processing thread. Thus, with the example illustrated in FIG. 4, the initial results data set obtained by the second processing thread may include data for the cell 403 falling within the design layer entitled METAL1 (e.g., the data describing the geometric element 405A representing the metal wire). Alternately, the initial results data set obtained by the second processing thread may include data for the cell 407 (i.e., Cell A) falling within the design layer entitled METAL_FILL (e.g., the describing the geometric elements 411 representing the fill structures in Cell A).

If the second set of initial results data accessed by the second processing thread includes data for the cell 407 falling within the design layer entitled METAL_FILL, then this data will be associated with a different target category of the organizational arrangement desired for the output data (i.e., “Cell A”). That is, for initial results data generated by an electronic design automation tool in the Calibre family of electronic design automation tools, the second set of initial results data will have a cell/layer coordinate value corresponding to the cell 407. In response, in step S509 the second processing thread stores data from the second initial results data set that belongs to the second target category of the organizational arrangement desired for the output data at a second memory location.

For example, referring back to FIG. 4, the cell 407 includes geometric elements 411 that represent metal fill structures to establish a desired structure density. Accordingly, the second processing thread will store the data describing the geometric elements 411 at a second memory location corresponding to the hierarchical cell 407 (i.e., “Cell A”). As previously noted, with some implementations of the invention, the processing threads may employ an offset map to record the memory location at which the initial results data set belonging to a target category of the organizational arrangement is stored. Thus, the second processing thread may employ an offset map associated with the hierarchical cell 407. When the second processing thread stores the initial results data describing the geometric elements 411, it will lock both the offset map and the temporary database. After storing the initial results data describing the geometric elements 411 at another memory location (e.g., a location in a memory device ranging from memory address j to memory address k), it will update the offset map for the cell 407 to include a reference to this second memory location. It would then release both the offset map and the temporary database.

If, however, the second set of initial results data accessed by the second processing thread includes data for the cell 403 falling within the design layer entitled METAL1, then this data will still be associated with the target category of the organizational arrangement desired for the output data (i.e., “Topcell”). In response, the second processing thread stores data from the second initial results data set that belongs to the first target category of the organizational arrangement desired for the output data at another memory location associated with that target category. For example, while the data representing the geometric elements 405B were stored in the temporary database at a memory location ranging from memory address 0 to memory address x, the data describing the geometric element 405A may be stored in the temporary database at a memory location ranging from memory address y to memory address z. As previously discussed, when the second processing thread stores the initial results data describing the geometric elements 405B, it will lock both the offset map for the cell 403 and the temporary database. After storing the initial results data describing the geometric elements 405B at memory addresses ranging from memory address y to memory addresses z), it will update the offset map for the cell 403 to include a reference to this second memory location. It will then release both the offset map and the temporary database.

Then, in step S511, the second processing thread converts the stored data into the desired data format. Again, with various implementations of the invention, the second processing thread may use any conventional technique or combination of techniques to convert the stored data into the desired data format. Also, as previously noted, with alternate examples of the invention the second processing thread may convert the data before storing it at the second memory location.

As will be appreciated by those of ordinary skill in the art, both the first processing thread and the second processing thread may operate substantially concurrently in a parallel processing arrangement. For example, the first and second processing threads may be run in parallel by a multi-core processing unit, as discussed in detail above. Alternately, the first and second processing threads may be run in parallel by different processor units operating in a parallel computing environment, as also discussed in detail above. For example, the first thread may be instantiated as part of a first electronic design automation process hosted on one computer in a parallel processing network, while the second processing thread may be instantiated as part of a second electronic design automation process hosted on another computer in the parallel processing network.

Also, while only two processing threads have been discussed for ease of understanding, it should be appreciated that various embodiments of the invention may employ three or more different processing threads, each operating in parallel on its own set of the initial data results. As will be discussed in more detail below, the parallel use of several processing threads can be advantageously employed to substantially reduce the amount of time required to output the initial results data into a desired data format.

This use of parallel processing threads may be is particularly beneficial if each of the threads operates on substantially equivalent set of initial results data, and if the number of independent processing threads is relatively large. Typically, however, the cells in a hierarchical circuit design will not contain equivalent data. Moreover, in some circumstances, the initial results data produced by an electronic design automation processes may not even have a hierarchical organization. Accordingly, some examples of the invention partition the initial results data based upon both a natural organization of the data and blocks of a specified size.

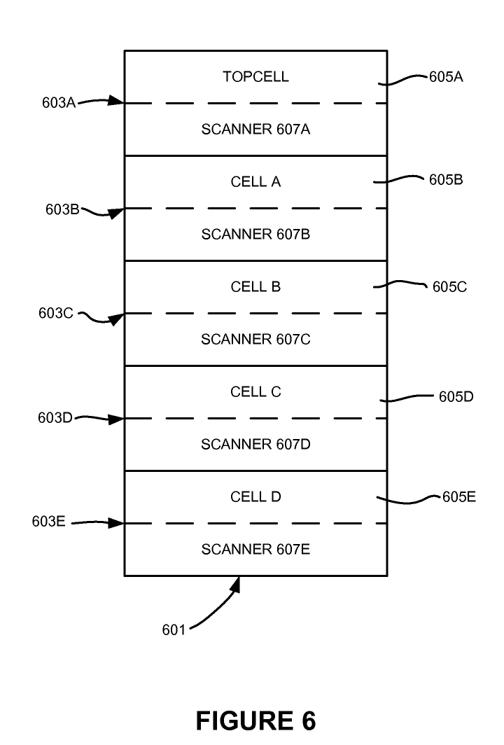

For example, some implementations of the invention may employ a stack or other queue structure to partition the initial results data provided by the electronic design automation process or processes. More particularly, the electronic design automation process (or other tool being used to output the data) may create a stack for each layer of result data in the hierarchical database. As shown in FIG. 6, the stack includes a stack item 603 for each cell associated with the layer of result data. Thus, in the illustrated example, the stack 601 includes a stack item 603A corresponding to the cell 403 (i.e., “Topcell”), a stack item 603B corresponding to the cell 407 (i.e., “Cell A”), a stack item 603C corresponding to the cell 409 (i.e., “Cell B”), a stack item 603C corresponding to the cell 413 (i.e., “Cell B”), and a stack item 603C corresponding to the cell 415 (i.e., “Cell D”). Each stack item 603 contains a pointer 605 to its corresponding cell/layer coordinate value, and a scanner 607. As known in the art, a scanner is a data object that holds state and scans items in a database. In addition, the stack item may contain a pointer pointing to, e.g., the offset map for its associated cell.

With the implementation illustrated in FIG. 6, each scanner 607 will scan the initial results data (which may be contained within, e.g., a hierarchical database), and retrieve the geometric element data contained associated with its layer and cell. Further, with some implementations of the invention, the scanner can be limited to retrieve only a predetermined number of items at a time. For example, each scanner 607 may be configured to retrieve data in segments of e.g., 64 k rectangles, 64 k polygons, or 64 k vertices for a vary large polygon. The scanner 607 will then save its state, i.e., an identifier (such as a memory address) identifying the last data that it retrieved for that layer and cell.

Accordingly, with various examples of the invention, each independent process thread provided will initially check if the stack is empty. If the stack is empty, then the addition phase of the conversion process is completed. Otherwise, a processing thread will lock the stack, pull the next item from the stack, and unlock the stack. The processing thread will then employ the scanner 607 in the pulled stack item 603 to access a set of initial results data, which the thread will then process as discussed in detail above. That is, based upon the value of the scanner, the processing thread will access the next, e.g., 64 k of initial results data for temporary storage and conversion as discussed above. It should be appreciated, however, that the particular amount of data accessed by a processing thread can be varied to trade off data conversion time against the degree of compression desired in the converted data. This amount may take into account the time that a processing thread will require to convert a set of initial results data to the desired output data format and then to the return to the stack for a new set of initial results data, as will be discussed below.

If the state of the scanner 607 indicates that there is additional initial results data for the cell for that layer in the data hierarchical database, then the processing thread will lock the stack, return the stack item 603 to the stack 601, and unlock the stack. It should be appreciated that, according to different examples of the invention, the stack may either be a first-in, first-out (FIFO) type stack or a last-in, first-out (LIFO) type stack. If the state of the scanner 607 indicates that there is no further initial results data for the cell and layer associated with that stack item 603, then the processing thread will discard the stack item 603. As previously discussed, the processing thread will convert the retrieved set of initial results data into the desired data format, and save the converted information in the temporary database for subsequent use in the conclusion phase. Each independent processing thread can repeat this process until no further data in a layer needs to be converted. This technique can then be performed for each layer of initial results data, until all of the initial results data has been converted into the desired data format.

It should be noted that various embodiments of the invention can access and convert initial results data in the manner described above, even if the initial results data are not organized into a particular organizational arrangement. For example, if the initial results data has no hierarchical organizational arrangement (sometimes referred to as “flat”), then various implementations of the invention may, e.g., employ a stack 601 with only a single stack item 603. This single stack item 603 then will correspond to all of the initial results data in a layer (or even all of the initial results data in a design if the design is not organized into layers). Each processing thread can then employ this single stack item 603 in sequence, as discussed above, until all of the initial results data to which the stack item 603 corresponds has been converted and stored in the temporary database.

As will be appreciated by those of ordinary skill in the art, having multiple threads convert and store portions of the initial results data in parallel can substantially reduce the amount of time required to generate the desired output data. The benefits provided by the parallel use of multiple processing threads may be particularly substantial where the initial results data is being converted from a data format using relatively little compression to an output data format that uses a relatively large amount of compression, such as the OASIS data format.

Turning now to the second or “conclusion” phase, in step S513 a processing thread collects the converted initial results data and provide the collected data as output data. Thus, with the example discussed above, the processing thread will use the offset map associated with the cell 403 to retrieve all of converted data associated with that cell (i.e., the converted data describing the geometric element 405 stored at memory address 0 to memory address x, and the converted data describing the geometric elements 405B stored at memory address y to memory address z). The processing thread will also retrieve the placements within the cell 403 based upon the cell description in the original data format. The processing thread can then output the converted data and the cell placements as a description of the cell 403 in the desired output format.

It should be appreciated that, with the initial results data having been converted to the desired output data format during the addition phase, a single processing thread typically will be able to collect and output all of the converted results data in the conclusion phase. With various implementations of the invention, the processing thread can provide the output data in any desired medium. It may, for example, write the output data to a storage medium such as a magnetic disk drive, transmit the output data to another computing device, display the output data on a display device, or even print the output data.

While particular implementations of embodiments of the invention have been described, it should be appreciated that a number of variations are well within the scope of the invention. For example, depending upon the electronic design automation process or processes involved, a set of initial results data may include data for two or more different target categories. Thus, a set of initial results data may include some geometric elements belonging to a first cell and other geometric elements belonging to a second, different cell. As previously noted above, the geometric elements may, e.g., each may include category information indicating to which target category (e.g., cell) it belongs. With these implementations of invention, two or more processing threads may operate in parallel on the same set of initial results data. For example, one processing thread may analyze the set of initial results data to identify, store and convert data in the set belonging to a first target category. A second processing thread can then concurrently analyze the same set of initial results data to identify, store and convert data in the set belonging to a first target category.

Still further, some implementations of the invention could process multiple categories of the initial results data simultaneously. Thus, with the example discussed above, various implementations of the invention could process multiple stacks in parallel, with one stack corresponding to each layer of the initial results data. Alternately or additionally, some embodiments of the invention might use a having multiple scanners in each stack item, with each scanner corresponding to a different cell/layer combination.

Yet further, while implementations of the invention have been described for outputting data in the OASIS data format, it will be appreciated that various implementations of the invention may be employed to output data in any desired data format, including, for example, the GDSII data format. Still further, various implementations of the invention may even be employed to convert data in a first format, such as the GDSII data format, to data in another format, such as the OASIS data format. These implementations of invention may, for example, treat the data in the GDSII data format as the initial results data. Additionally, while specific organizational arrangements (e.g., layer and hierarchal) have been discussed above, it should be appreciated that various implementations of the invention may be employed with other types o organizational arrangements, such as arrangement based upon area, logical connections, or timing constraints.

### CONCLUSION

The present invention has been described in terms of preferred and illustrative embodiments thereof. Numerous other embodiments, modifications and variations within the scope and spirit of the appended claims will occur to persons of ordinary skill in the art from a review of this disclosure, however, and it should be appreciated that these are encompassed by the following claims as well.

1. Outputting layout data that represents a circuit design wherein the layout data is arranged according to a first organizational arrangement for processing and arranged according to a second organizational arrangement for storage or transmission, comprising:
with a first processing thread
accessing a first data set arranged according to the first organizational arrangement, and
storing data within the first data set belonging to a first target category of the second organizational arrangement at a first memory portion; and with a second processing thread
accessing a second data set arranged according to the first organizational arrangement, and
storing data within the second data set belonging to a second target category of the second organizational arrangement
so that the layout data of the first organizational arrangement stored in the first and second memory portions by the first and second processing threads is arranged in first and second target categories of the second organizational arrangement.

2. The method recited in claim 1, wherein the first processing thread operates substantially in parallel with the second processing thread.

3. The method recited in claim 1, wherein the first data set at least partially overlaps the second data set.

4. The method recited in claim 1, wherein the first processing thread
pulls a stack item from a stack, the stack item corresponding to the first target category and containing at least a scanner and a pointer pointing to the first memory portion, and
employs the scanner to designate the first data set.

5. The method recited in claim 4, wherein the first processing thread updates the scanner, and
if the scanner indicates that the group of group of data belonging to the initial category still includes unaccessed data, then returns the stack item to the stack.

6. The method recited in claim 4, wherein the stack is a first in, first out (FIFO) stack.

7. The method recited in claim 4, wherein the stack is a last in, first out (LIFO) stack.

8. The method recited in claim 4, wherein
the stack item includes a second scanner that references a second group of data belonging to a second initial category according to the first organizational arrangement, and
further comprising having a second processing thread
retrieve a first data set from the second group of data belonging to the second initial category,
identify data within the first data set from the second group of data that should belong to the first target category, and
store the data that should belong to the first target category in the first memory portion.

9. The method recited in claim 4, further comprising having a third processing thread
pull a second stack item from a second stack, the second stack item corresponding to the first target category and containing at least a second scanner and a second pointer pointing to the first memory portion
employ the scanner to designate a first data set from a second group of data belonging to a second initial category according to the first organizational arrangement,
retrieve the second data set from the second group of data,
identify data within the second data set from the second group of data that should belong to the first target category, and
employ the second pointer to store the data within the second data set from the second group of data that should belong to the first target category in the first memory portion.

10. The method recited in claim 1, wherein the first data set at least partially overlaps the second data set.

11. The method recited in claim 1, wherein
the initial category in the first organizational arrangement includes all structures of a specified type in an electronic circuit design;
the first target category in the second organizational arrangement encompasses all components of a first hierarchical design unit; and
the second target category in the second organizational arrangement encompasses all components of a second hierarchical design unit.

12. The method recited in claim 11, wherein the second hierarchical design unit is a component of the first hierarchical design unit.

13. A method of converting data from a first data format to a second data format, comprising:
employing a plurality of processing threads to reorganize data in a first data format as recited in claim 1, and
employing at least one processing thread to convert the reorganized data from the first data format to a second data format.

14. The method of converting data from a first data format to a second data format recited in claim 13, wherein the second data format is the Open Artwork System Interchange Standard (OASIS) data format or the Graphic Data System II (GDSII) data format.

15. A method of outputting data produced in a first organizational arrangement as a second organizational arrangement, comprising:
with a first processing thread
pulling a first stack item from a stack, the first stack item containing at least a first scanner that references an initial data category according to an initial organizational arrangement,
employing the first scanner to access a first data set in a group of data belonging to the initial category, and
storing data that belonging to the first target category in a first memory portion; and
with a second processing thread
pulling a second stack item from a stack, the second stack item containing at least a second scanner that references the initial data category,
employing the second scanner to access a second data set in a group of data belonging to the initial data category, and
storing data belonging to a second target category in the second memory portion.

16. The method recited in claim 15, wherein the first processing thread operates substantially in parallel with the second processing thread.

17. The method recited in claim 15, wherein the first data set at least partially overlaps the second data set.

18. The method recited in claim 15, further comprising
having the first processing thread
update the first scanner, and
if the first scanner indicates that the group of data belonging to the initial category still includes unaccessed data, then returning the first stack item to the stack, and
having the second processing thread
update the second scanner, and
if the second scanner indicates that the group of data belonging to the initial category still includes unaccessed data, then returning the second stack item to the stack.

19. The method recited in claim 15, wherein the stack is a first in, first out (FIFO) stack.

20. The method recited in claim 15, wherein the stack is a last in, first out (LIFO) stack.

21. The method recited in claim 15, wherein the first stack item includes a scanner that references a second group of data belonging to a second initial category according to the first organizational arrangement, and
further comprising having a third processing thread
retrieve a first data set from the second group of data belonging to the second initial category,
identify data within the first data set from the second group of data that should belong to the first target category, and
store the data that should belong to the first target category in the first memory portion.

22. A computer storage medium including a sequence of program instructions stored thereon that are executable by a computer system to perform the method recited in claim 1.

23. A computer storage medium including a sequence of program instructions stored thereon that are executable by a computer system to perform the method recited in claim 13.

24. A computer storage medium including a sequence of program instructions stored thereon that are executable by a computer system to perform the method recited in claim 15.
